(19) United States
(12) Patent Application Publication
(10) Pub. No.: US 2021/0216759 A1
(43) Pub. Date: Jul. 15, 2021

(54) RECOGNITION METHOD, COMPUTER-READABLE RECORDING MEDIUM RECORDING RECOGNITION PROGRAM, AND LEARNING METHOD

(71) Applicant: FUJITSU LIMITED, Kawasaki-shi (JP)

(72) Inventors: Yoshihisa Asayama, Kawasaki (JP); Shoichi Masui, Sagamihara (JP)

(73) Assignee: FUJITSU LIMITED, Kawasaki-shi (JP)

(21) Appl. No.: 17/219,016

(22) Filed: Mar. 31, 2021

Related U.S. Application Data
(63) Continuation of application No. PCT/JP2018/039215, filed on Oct. 22, 2018.

(51) Int. Cl. G06K 9/00; G06T 7/70; G06N 3/08

(52) U.S. Cl. CPC G06K 9/00369; G06T 2207/30196; G06N 3/08; G06T 7/70

(57) ABSTRACT

A recognition method in which a computer executes processing includes: generating posture information used to specify a posture of a subject on the basis of a distance image that includes the subject; inputting the distance image and the posture information to a learned model that is learned to recognize a skeleton of the subject; and specifying the skeleton of the subject using an output result of the learned model.

### CROSS-REFERENCE TO RELATED APPLICATION

This application is a continuation application of International Application PCT/JP2018/039215 filed on Oct. 22, 2018 and designated the U.S., the entire contents of which are incorporated herein by reference.

### FIELD

The embodiments discussed herein are related to a recognition method, a recognition program, a recognition device, a learning method, a learning program, and a learning device.

### BACKGROUND

In a wide range of fields such as gymnastics and medical care, skeletons of persons such as athletes and patients are recognized. For example, a technique has been known for extracting a change region image that changes using a background image from an input image including an object and detecting a position of the object by combining the input image and the change region image and using a convolutional neural network. Furthermore, a technique has been known for estimating a heat map image that indicates a reliability of existence of limbs according to a learning model using an image as an input and calculating positions of limbs on the basis of the estimation result.

Japanese Laid-open Patent Publication No. 2017-191501 and Japanese Laid-open Patent Publication No. 2017-211988 are disclosed as related art.

### SUMMARY

According to an aspect of the embodiments, a recognition method in which a computer executes processing includes: generating posture information used to specify a posture of a subject on the basis of a distance image that includes the subject; inputting the distance image and the posture information to a learned model that is learned to recognize a skeleton of the subject; and specifying the skeleton of the subject using an output result of the learned model.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an overall configuration example of a system including a recognition device according to a first embodiment;

FIG. 2 is a diagram for explaining learning processing and recognition processing according to the first embodiment;

FIG. 3 is a functional block diagram illustrating a functional configuration of a learning device and the recognition device according to the first embodiment;

FIG. 4 is a diagram stating an example of definition information stored in a skeleton definition DB;

FIG. 5 is a diagram illustrating an example of earning data stored in a learning data DB;

FIGS. 6A and 6B are diagrams illustrating an example of a distance image and a heat map image;

FIG. 7 is a flowchart illustrating a flow of processing according to the first embodiment;

FIG. 8 is a diagram for explaining a comparative example of a recognition result of skeleton information;

FIG. 9 is a diagram for explaining an input of posture information;

FIG. 10 is a diagram for explaining an angle value and a trigonometric function; and

FIG. 11 is a diagram for explaining a hardware configuration example.

### DESCRIPTION OF EMBODIMENTS

Furthermore, taking the artistic gymnastics as an example, in recent years, a distance image that is three-dimensional data of an athlete is acquired using a Three-dimensional (3D) laser sensor, a skeleton including an orientation of each joint and an angle of each joint of the athlete is recognized from the distance image, and a performed technique or the like is rated.

By the way, it is considered to use machine learning such as deep learning (Deep Learning (DL)) to recognize a skeleton including each joint. Taking the deep learning as an example, at the time of learning, a learning model is learned that acquires a distance image of a subject with a 3D laser sensor, inputs the distance image to a neural network, and recognizes each joint through deep learning. At the time of recognition, a method is considered for inputting the distance image of the subject acquired with the 3D laser sensor to a learned learning model, acquiring a heat map image indicating an existence probability (likelihood) of each joint, and recognizing each joint.

However, in a case where the learning model using machine learning is simply applied to skeleton recognition or the like, recognition accuracy is low. For example, because an orientation of a person is not found from the distance image, left-and-right paired joints in the human body such as positions of elbows, wrists, knees, limbs, or the like are recognized in an opposite joint in comparison with correct joints.

In one aspect, a recognition method, a recognition program, a recognition device, a learning method, a learning program, and a learning device that can improve accuracy of skeleton recognition using a learning model using machine learning may be provided.

Hereinafter, examples of a recognition method, a recognition program, a recognition device, a learning method, a learning program, and a learning device according to the embodiments will be described in detail with reference to the drawings. Note that the present invention is not limited to the embodiments. In addition, each of the embodiments may be appropriately combined within a range without inconsistency.

### First Embodiment

[Overall Configuration]

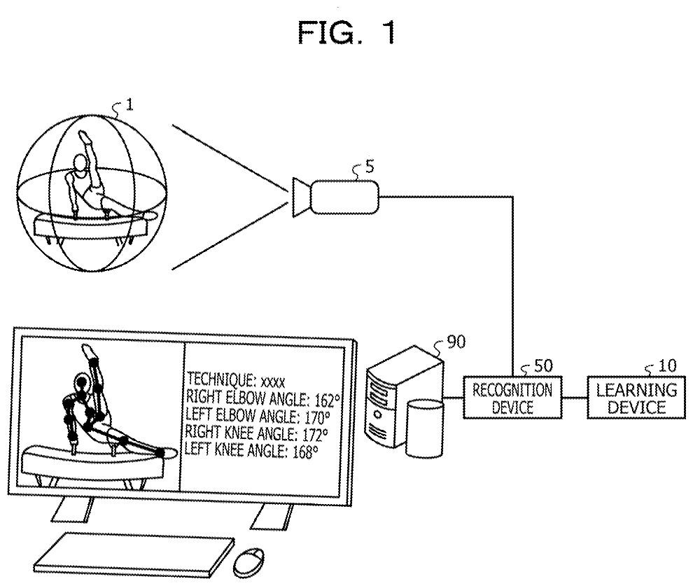

FIG. 1 is a diagram illustrating an overall configuration example of a system including a recognition device according to a first embodiment. As illustrated in FIG. 1, this system is a system that includes a 3D laser sensor 5, a learning device 10, a recognition device 50, and a rating device 90 and images 3D data of a performer 1 who is a subject and recognizes a skeleton or the like to accurately rate techniques. Note that, in the present embodiment, as an example, an example will be described in which skeleton information of a performer in the artistic gymnastics is recognized.

Typically, a current rating method in the artistic gymnastics is visually performed by a plurality of judges. However, it is difficult for the judges to visually perform rating for advanced techniques. In recent years, a technique has been developed for acquiring a distance image that is three-dimensional data of an athlete using a 3D laser sensor, recognizing a skeleton including an orientation of each joint and an angle of each joint of the athlete from the distance image, and rating a performed technique or the like. However, in learning using only the distance image, the orientation of the performer is not found. Therefore, there is a case where left-and-right paired joints in the human body such as positions of elbows, wrists, knees, or limbs are wrongly recognized. In accordance with occurrence of such wrong recognition, inaccurate information is provided to the judge, and occurrence of rating errors or the like due to misrecognition of performances and techniques is concerned.

Therefore, the recognition device 50 according to the first embodiment particularly recognizes a left joint and a right joint with high accuracy and without misrecognition when skeleton information of a person is recognized through deep learning using a distance image acquired from a 3D laser sensor.

First, each device included in a system in FIG. 1 will be described. The 3D laser sensor 5 is an example of a sensor device that measures (sensing) a distance to an object for each pixel using an infrared laser or the like. The distance image includes a distance to each pixel. That is, for example, the distance image is a depth image indicating a depth of a subject viewed from the 3D laser sensor (depth sensor) 5.

The learning device 10 is an example of a computer device that learns a learning model for skeleton recognition. Specifically, for example, the learning device 10 learns a learning model using machine learning such as deep learning using CG data acquired in advance or the like as learning data.

The recognition device 50 is an example of a computer device that recognizes a skeleton of a performer 1 regarding an orientation, a position, or the like of each joint using the distance image measured by the 3D laser sensor 5. Specifically, for example, the recognition device 50 inputs the distance image measured by the 3D laser sensor 5 into the learned learning model learned by the learning device 10 and recognizes the skeleton on the basis of an output result of the learning model. Thereafter, the recognition device 50 outputs the recognized skeleton to the rating device 90.

The rating device 90 is an example of a computer device that specifies the position and the orientation of each joint of the performer using the skeleton recognized by the recognition device 50 and specifies and rates a technique performed by the performer.

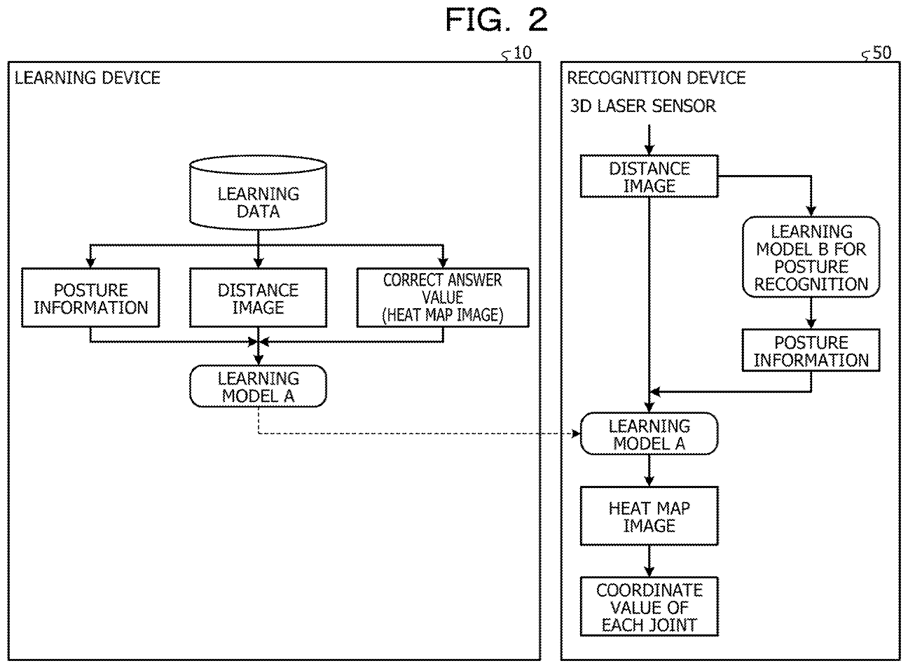

Here, learning processing and recognition processing will be described. FIG. 2 is a diagram for explaining learning processing and recognition processing according to the first embodiment. As illustrated in FIG. 2, the learning device 10 reads posture information, a distance image, and a heat map image indicating a correct answer value from learning data that is prepared in advance. Then, the learning device 10 inputs the posture information to a neural network when a learning model A is learned by using the neural network using teacher data in which the distance image is used as input data and the correct answer value is used as a correct answer label and performs learning.

Thereafter, when acquiring the distance image measured by the 3D laser sensor 5, the recognition device 50 inputs the acquired image to a learning model B for posture recognition that has been learned in advance and acquires the posture information. Then, the recognition device 50 inputs the measured distance image and the acquired posture information to the learned learning model A learned by the learning device 10 and acquires a heat map image as an output result of the learning model A. Thereafter, the recognition device 50 specifies, for example, a position (coordinate value) of each joint from the heat map image.

In this way, the above-described system can improve skeleton recognition accuracy by applying not only the distance image but also information (posture information) regarding an orientation of a person with respect to the 3D laser sensor 5 to the input data for machine learning in order to generate a learning model.

[Functional Configuration]

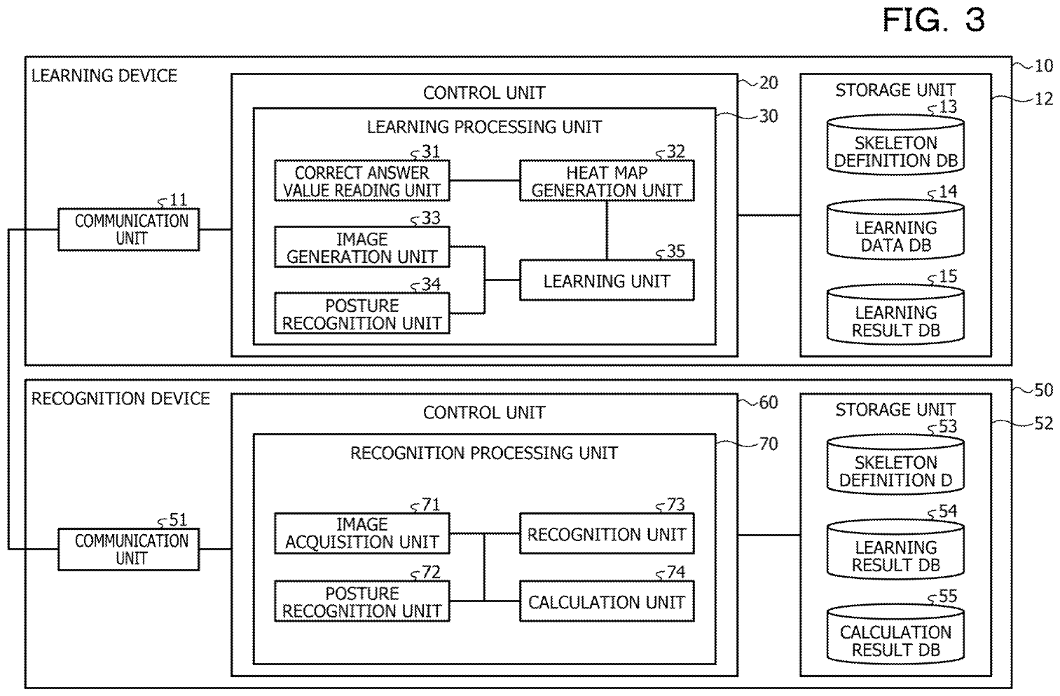

FIG. 3 is a functional block diagram illustrating a functional configuration of the learning device 10 and the recognition device 50 according to the first embodiment. Note that, because the rating device 90 has a configuration similar to a general device that determines accuracy of a technique using information regarding the joints or the like and rates a performance of a performer, detailed description thereof will be omitted.

(Functional Configuration of Learning Device 10)

As illustrated in FIG. 3, the learning device 10 includes a communication unit 11, a storage unit 12, and a control unit 20. The communication unit 11 is a processing unit that controls communication with other devices and is, for example, a communication interface or the like. For example, the communication unit 11 outputs a learning result or the like to the recognition device 50.

The storage unit 12 is an example of a storage device that stores data and a program executed by the control unit 20 or the like and is, for example, a memory, a hard disk, or the like. The storage unit 12 stores a skeleton definition DB 13, a learning data DB 14, and a learning result DB 15.

The skeleton definition DB 13 is a database that stores definition information used to specify each joint on a skeleton model. The definition information stored here may be measured for each performer through 3D sensing with the 3D laser sensor or may be defined using a general system skeleton model.

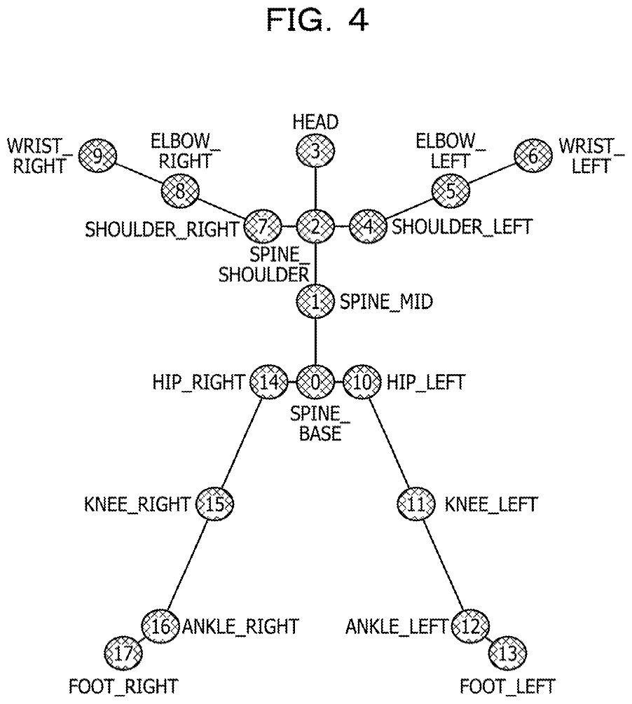

FIG. 4 is a diagram illustrating an example of the definition information stored in the skeleton definition DB 13. As illustrated in FIG. 4, the skeleton definition DB 13 stores 18 pieces (number zero to number 17) of definition information in which each joint specified in a known skeleton model is numbered. For example, as illustrated in FIG. 4, a right shoulder joint (SHOULDER_RIGHT) is assigned with number 7, a left elbow joint (ELBOW_LEFT) is assigned with number 5, a left knee joint (KNEE_LEFT) is assigned with number 11, and a right hip joint (HIP_RIGHT) is assigned with number 14. Here, in the embodiment, regarding the right shoulder joint of number 8, there is a case where the X coordinate is described as X8, the Y coordinate is described as Y8, and the Z coordinate is described as Z8. Note that, for example, the Z axis can define a distance direction from the 3D laser sensor 5 to a target, the Y axis can define a height direction perpendicular to the Z axis, and the X axis can define a horizontal direction.

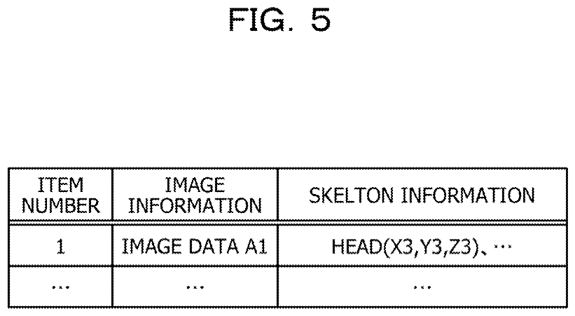

The learning data DB 14 is a database that stores learning data (training data) used to construct a learning model for recognition of a skeleton FIG. 5 is a diagram illustrating an example of the learning data stored in the learning data DB 14. As illustrated in FIG. 5, the learning data DB 14 stores “an item number, image information, and skeleton information” in association with each other.

The “item number” stored here is an identifier used to identify the learning data. The “image information” is data of a distance image of which a position of a joint or the like is known. The “skeleton information” is positional information of a skeleton and indicates a joint position (three-dimensional coordinates) corresponding to each of the 18 joints illustrated in FIG. 4. In other words, for example, the image information is used as input data and the skeleton information is used as a correct answer label for supervised learning. In the example in FIG. 4, “image data A1” that is a distance image indicates that positions of 18 joints including coordinates “X3, Y3, Z3” of HEAD or the like are known.

The learning result DB 15 is a database that stores learning results. For example, the learning result DB 15 stores determination results (classification result) of the learning data by the control unit 20 and various parameters learned through machine learning or the like.

The control unit 20 is a processing unit that controls the entire recognition device 50 and is, for example, a processor or the like. The control unit 20 includes a learning processing unit 30 and executes learning model learning processing. Note that the learning processing unit 30 is an example of an electronic circuit such as a processor or an example of a process included in a processor or the like.

The learning processing unit 30 is a processing unit that includes a correct answer value reading unit 31, a heat map generation unit 32, an image generation unit 33, a posture recognition unit 34, and a learning unit 35 and learns a learning model for recognizing each joint. Note that the posture recognition unit 34 is an example of a generation unit, the learning unit 35 is an example of an input unit and a learning unit, and the heat map generation unit 32 is an example of a generation unit.

The correct answer value reading unit 31 is a processing unit that reads a correct answer value from the learning data DB 14. For example, the correct answer value reading unit 31 reads “skeleton information” of learning data to be learned and outputs the read information to the heat map generation unit 32.

The heat map generation unit 32 is a processing unit that generates a heat map image. For example, the heat map generation unit 32 uses the “skeleton information” input from the correct answer value reading unit 31, generates a heat map image of each joint, and outputs the generated heat map image to the learning unit 35. In other words, for example, the heat map generation unit 32 generates a heat map image corresponding to each joint using the positional information (coordinates) of each of the 18 joints that is a correct answer value.

Note that various known methods can be adopted for the generation of the heat map image. For example, the heat map generation unit 32 sets a coordinate position read by the correct answer value reading unit 31 as a position with the highest likelihood (existence probability), sets a position from the position by a radius of X cm as a position with the next highest likelihood, and further sets a position from the position by a radius of X cm as a position with the next highest likelihood and generates a heat map image. Note that X is a threshold and is an arbitrary number. Furthermore, details of the heat map image will be described later.

The image generation unit 33 is a processing unit that generates a distance image. For example, the image generation unit 33 reads a distance image stored in the image information associated with the skeleton information read by the correct answer value reading unit 31, of the learning data stored in the learning data DB 14 and outputs the read distance image to the learning unit 35.

The posture recognition unit 34 is a processing unit that calculates posture information using the skeleton information of the learning data. For example, the posture recognition unit 34 calculates a rotation angle around the spine and a rotation angle around both shoulders using the positional information of each joint that is the skeleton information and the definition information regarding the skeleton stored in FIG. 4 and outputs the calculation result to the learning unit 35. Note that the axis of the spine is, for example, an axis connecting HEAD (3) and SPINE_BASE (0) illustrated in FIG. 4, and the axis of the both shoulders is, for example, an axis connecting SHOULDER RIGHT (7) and SHOULDER_LEFT (4) illustrated in FIG. 4.

The learning unit 35 is a processing unit that performs supervised learning on a learning model using deep learning using a multi-layered structure neural network as a learning model, that is, deep learning. For example, the learning unit 35 inputs distance image data generated by the image generation unit 33 and inputs the posture information generated by the posture recognition unit 34 to the neural network. Then, the learning unit 35 acquires a heat map image of each joint as an output of the neural network. Thereafter, the learning unit 35 compares the heat map image of each joint that is the output of the neural network and the heat map image of each joint that is the correct answer label generated by the heat map generation unit 32. Then, the learning unit 35 learns the neural network using backpropagation or the like so as to minimize an error of each joint.

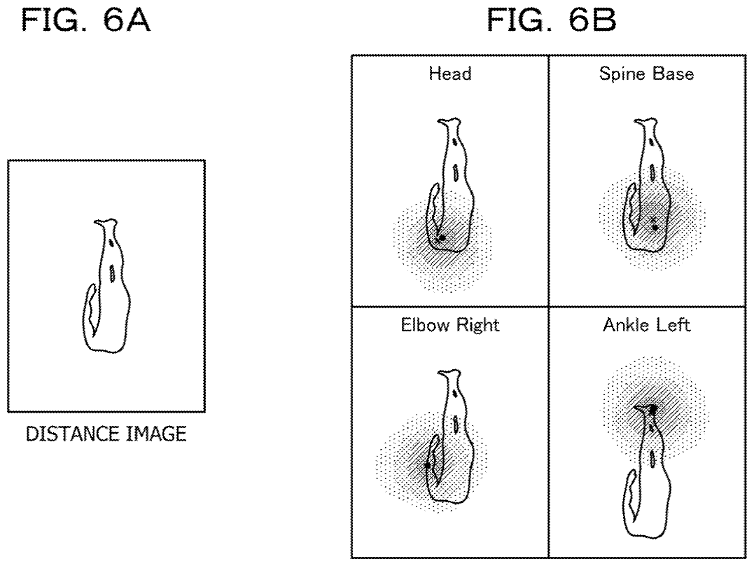

Here, the input data will be described. FIGS. 6A and 6B are diagrams illustrating an example of the distance image and the heat map image. As illustrated in FIG, 6A, the distance image is data including a distance from the 3D laser sensor 5 to a pixel, and the closer the distance from the 3D laser sensor 5 is, the darker the color of the image is displayed. Furthermore, as illustrated in FIG. 6B, the heat map image is an image that is generated for each joint and visualizes a likelihood of each joint position, and a coordinate position having the highest likelihood is displayed with the darker color. Note that, in the heat map image, a shape of a person is not normally displayed. Although the shape of the person is illustrated for easy description in FIGS. 6A and 6B, this does not limit a display format of an image.

Furthermore, when learning is terminated, the learning unit 35 stores various parameters or the like in the neural network in the learning result DB 15 as the learning results. Note that a timing when learning is terminated can be set to any timing, for example, at a time when learning using equal to or more than a predetermined number of pieces of learning data is completed, a time when an error falls below a threshold, or the like.

(Functional Configuration of Recognition Device 50)

As illustrated in FIG. 3, the recognition device 50 includes a communication unit 51, a storage unit 52, and a control unit 60. The communication unit 51 is a processing unit that controls communication with other devices and is, for example, a communication interface or the like. For example, the communication unit 51 acquires the learning result from the learning device 10, acquires the distance image from the 3D laser sensor 5, and transmits the skeleton information of the performer 1 to the rating device 90.

The storage unit 52 is an example of a storage device that stores data and a program executed by the control unit 60 or the like and is, for example, a memory, a hard disk, or the like. The storage unit 52 stores a skeleton definition DB 53, a learning result DB 54, and a calculation result DB 55. Note that, because the skeleton definition DB 53 stores information similar to the skeleton definition DB 13 and the learning result DB 54 stores information similar to the learning result DB 15 detailed description thereof will be omitted.

The calculation result DB 55 is a database that stores information regarding each joint calculated by the control unit 60 to be described later. Specifically, for example, the calculation result DB 55 stores a result recognized from the distance image by the recognition device 50.

The control unit 60 is a processing unit that controls the entire recognition device 50 and is, for example, a processor or the like. The control unit 60 includes a recognition processing unit 70 and executes learning model learning processing. Note that the recognition processing unit 70 is an example of an electronic circuit such as a processor and an example of a process included in a processor or the like.

The recognition processing unit 70 is a processing unit that includes an image acquisition unit 71, a posture recognition unit 72, a recognition unit 73, and a calculation unit 74 and performs skeleton recognition. Note that the posture recognition unit 72 is an example of a generation unit, the recognition unit 73 is an example of an input unit, and the calculation unit 74 is an example of a specification unit.

The image acquisition unit 71 is a processing unit that acquires a distance image of a skeleton recognition target. For example, the image acquisition unit 71 acquires the distance image measured by the 3D laser sensor 5, and outputs the distance image to the posture recognition unit 72 and the recognition unit 73.

The posture recognition unit 72 is a processing unit that recognizes posture information from the distance image. For example, the posture recognition unit 72 inputs the distance image acquired by the image acquisition unit 71 to a learning model for posture recognition that has been learned in advance. Then, the posture recognition unit 72 outputs an output value output from the different learning model to the recognition unit 73 as the posture information. Note that, as the learning model for posture recognition used here, a known learning model or the like can be used, and a known calculation formula or the like can be adopted in addition to the learning model. In other words, for example, any method can be used as long as the posture information can be acquired from the distance image.

The recognition unit 73 is a processing unit that executes the skeleton recognition using the learned learning model learned by the learning device 10. For example, the recognition unit 73 reads various parameters stored in the learning result DB 54 and constructs a learning model using a neural network to which various parameters are set.

Then, the recognition unit 73 inputs the distance image acquired by the image acquisition unit 71, the posture information acquired by the posture recognition unit 72 to the constructed learned learning model and recognizes the heat map image of each joint as an output result. In other words, for example, the recognition unit 73 acquires the heat map image corresponding to each of the 18 joints using the learned learning model and outputs the heat map image to the calculation unit 74.

The calculation unit 74 is a processing unit that calculates a position of each joint from the heat map image of each joint acquired by the recognition unit 73. For example, the calculation unit 74 acquires the coordinates with the maximum likelihood in the heat maps of the respective joints. That is, for example, the calculation unit 74 acquires the coordinates with the maximum likelihood for the heat map image of each of the 18 joints such as a heat map image of HEAD (3) and a heat map image of SHOULDER_RIGHT (7).

Then, the calculation unit 74 stores the coordinates with the maximum likelihood of each joint in the calculation result DB 55 as a calculation result. At this time, the calculation unit 74 can convert the coordinates (two-dimensional coordinates) of the maximum likelihood acquired for each joint into three-dimensional coordinates. For example, the calculation unit 74 performs calculation as a right elbow angle=162 degrees, a left elbow angle=170 degrees, or the like.

[Flow of Processing]

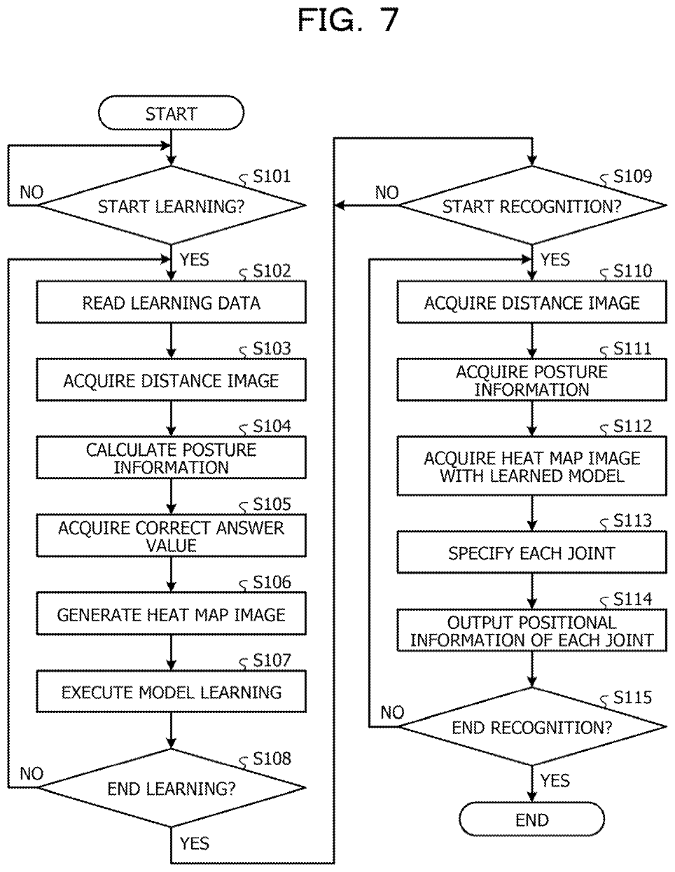

FIG. 7 is a flowchart illustrating a flow of processing according to the first embodiment. Note that, here, an example will be described in which recognition processing is executed after learning processing. However, the embodiment is not limited to this, and can be realized by separate flows.

As illustrated in FIG. 7, when receiving an instruction to start learning (S101: Yes), the learning device 10 reads learning data from the learning data DB 14 (S102).

Subsequently, the learning device 10 acquires a distance image from the read learning data (S103) and calculates posture information from skeleton information of the learning data (S104). Furthermore, the learning device 10 acquires the skeleton information that is a correct answer value from the learning data (S105) and generates a heat map image of each joint from the acquired skeleton information (S106).

Thereafter, the learning device 10 inputs the distance image as input data and the heat map image of each joint as a correct answer label to the neural network and inputs the posture information to the neural network and learns a model (S107). Here, in a case where learning is continued (S108: No), steps in and subsequent to S102 are repeated.

Then, after learning is terminated (S108: Yes), when receiving an instruction to start recognition (S109: Yes), the recognition device 50 acquires a distance image from the 3D laser sensor 5 (S110).

Subsequently, the recognition device 50 inputs the distance image acquired in S110 to a learning model for posture recognition that has been learned in advance and acquires the output result as the posture information (S111). Thereafter, the recognition device 50 inputs the distance image acquired in S110 and the posture information acquired in S111 to the learned learning model learned in S107 and acquires the output result as the heat map image of each joint (S112).

Then, the recognition device 50 acquires positional information of each joint on the basis of the acquired heat map image of each joint (S113) and converts the acquired positional information of each joint into two-dimensional coordinates or the like and outputs the converted information to the calculation result DB 55 (S114).

Thereafter, in a case where the skeleton recognition is continued (S115: No), the recognition device 50 repeats processing in and subsequent to S110, and in a case where skeleton recognition is terminated (S115: Yes), the recognition device 50 terminates the recognition processing.

[Effects]

As described above, when recognizing a joint or the like of a person through deep learning using the distance image acquired from the 3D laser sensor 5, the recognition device 50 gives information (posture information) regarding an orientation of a person with respect to the 3D laser sensor 5 to the neural network. In other words, for example, information from which the right side and the left side of the person in the distance image can be recognized is given to machine learning such as deep learning. As a result, the recognition device 50 can correctly recognize left-and-right paired joints in the human body such as elbows, wrists, knees, or the like without wrongly recognizing the left and right.

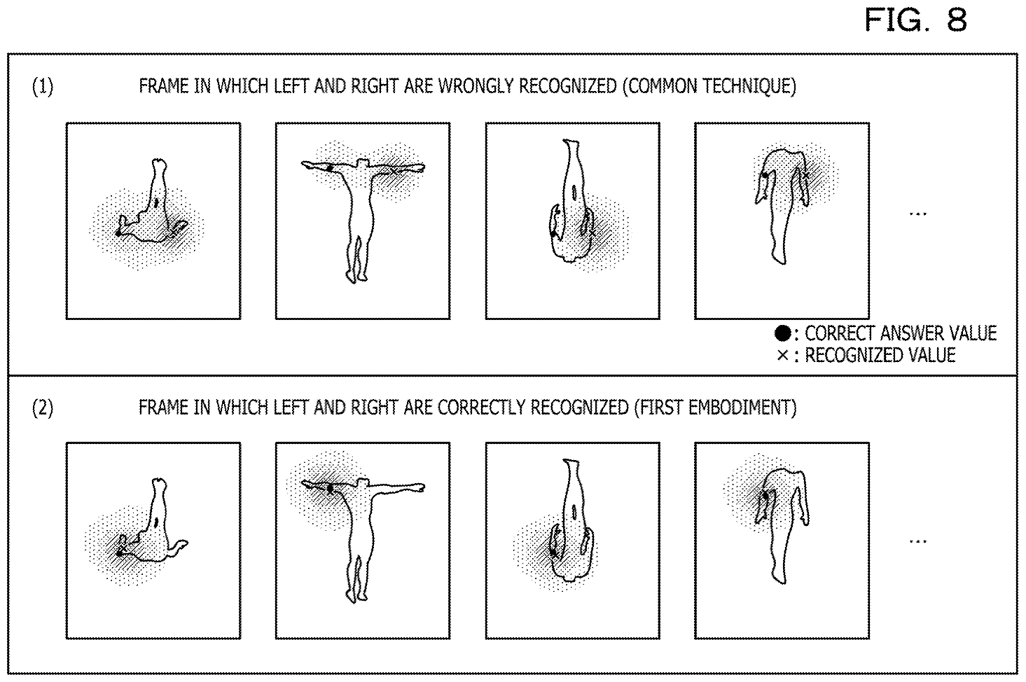

FIG. 8 is a diagram for explaining a comparative example of a recognition result of the skeleton information. In FIG. 8, a heat map image of each joint obtained from the learned learning model is illustrated. A black circle in FIG. 8 indicates a correct answer value (position) of a known joint, and a cross mark in FIG. 8 indicates a position of a joint that is finally recognized. Furthermore, as an example, in FIG. 8, heat map images of four joints will be illustrated and described.

As illustrated in (1) of FIG. 8, in the common technique, even if learning is performed while correctly recognizing the left and the right at the time of learning, there is a case where the left and the right are recognized in reverse to the learning data at the time of recognition even if the distance image is in the same orientation as the learning data, and it is not possible to obtain an accurate recognition result.

On the other hand, as illustrated in (2) of FIG. 8, the learning model using the method according to the first embodiment learns and estimates the skeleton recognition using not only the distance image but also the posture information. Therefore, the recognition device 50 according to the first embodiment can perform the skeleton recognition by the learning model using the distance image and the posture information as the input data and can output the recognition result in which the left and the right are correctly recognized.

### Second Embodiment

By the way, in the first embodiment, the generation of the learning model using the deep learning that uses the multi-layered structure neural network as a learning model has been described. However, the learning device 10 and the recognition device 50 can control a layer to which the posture information is input. Note that, here, although the recognition device 50 will be described as an example, the learning device 10 can execute similar processing.

For example, the neural network has a multi-stage structure including an input layer, an intermediate layer (hidden layer), and an output layer, and each layer has a structure in which a plurality of nodes is connected with edges. Each layer has a function called an “activation function”, and an edge has a “weight”. A value of each node is calculated from a value of a node of a previous layer, a value of a weight of a connection edge (weight coefficient), and an activation function of a layer. Note that, as a calculation method, various known methods can be adopted.

Furthermore, learning in the neural network is to correct the parameters, in other words, for example, the weights and biases so that the output layer has a correct value. In the backpropagation, a “loss function (loss function)” indicating how far a value of an output layer is separated from a correct state (desired state) is defined for the neural network, and weights and biases are updated so as to minimize the loss function using the steepest descent method or the like. Specifically, for example, an input value is given to a neural network, the neural network calculates a predicted value on the basis of the input value, an error is evaluated by comparing the predicted value and teacher data (correct answer value), and a value of a coupling load (synaptic coefficient) in the neural network is sequentially corrected on the basis of the obtained error so as to learn and construct a learning model.

The above-described recognition device 50 can use a Convolutional Neural Network (CNN) or the like as a method using such a neural network. Then, at the time of learning or recognition, the recognition device 50 performs learning or recognition by inputting the posture information to the first intermediate layer of the intermediate layers included in the neural network. In this way, because a feature amount can be extracted by each intermediate layer in a state where the posture information is input, it is possible to improve joint recognition accuracy.

Furthermore, in a case of a learning model using the CNN, the recognition device 50 can input the posture information to the smallest layer among the intermediate layers and can perform learning and recognition. The CNN includes a convolutional layer and a pooling layer as the intermediate layers (hidden layer). The convolutional layer executes filter processing on a close node in the previous layer so as to generate a feature map, and the pooling layer further reduces the feature map output from the convolutional layer so as to generate a new feature map. That is, for example, the convolutional layer extracts a local feature of an image, the pooling layer executes processing for aggregating the local features, and this reduces the image while maintaining the features of the input image.

Here, the recognition device 50 inputs the posture information to a layer having the smallest input image input to each layer. As a result, it is possible to input the posture information in a state where the largest number of features of the input image (distance image) input to the input layer are extracted, and it is possible to restore the original image from the feature amount thereafter in consideration of the posture information. Therefore, it is possible to improve the joint recognition accuracy.

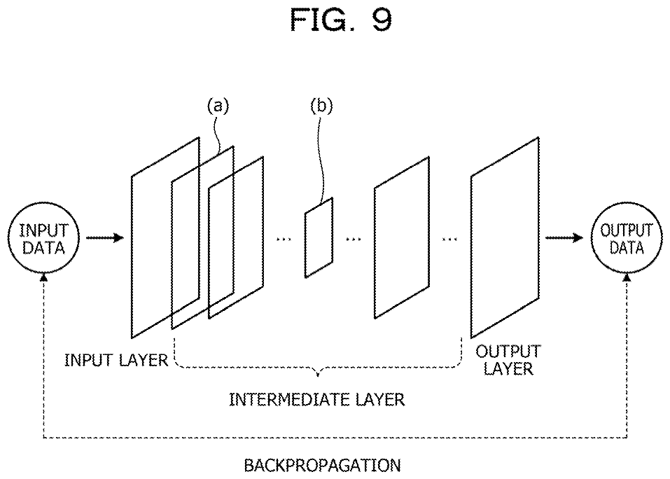

Here, this will be specifically described using FIG. 9. FIG. 9 is a diagram for explaining an input of posture information. As illustrated in FIG. 9, a neural network includes an input layer, an intermediate layer (hidden layer), and an output layer, and learning is performed so as to minimize an error between input data of the neural network and output data output from the neural network. At this time, the recognition device 50 inputs the posture information to a layer (a) that is a first layer of the intermediate layers, and executes learning processing and recognition processing. Alternatively the recognition device 50 inputs the posture information to a layer (b) in which an input image to be input to each layer is minimized and executes the learning processing and the recognition processing.

### Third Embodiment

Here, although the embodiments have been described above, the present invention may be implemented in various different forms in addition to the embodiments described above.

[Input Value of Posture Information]

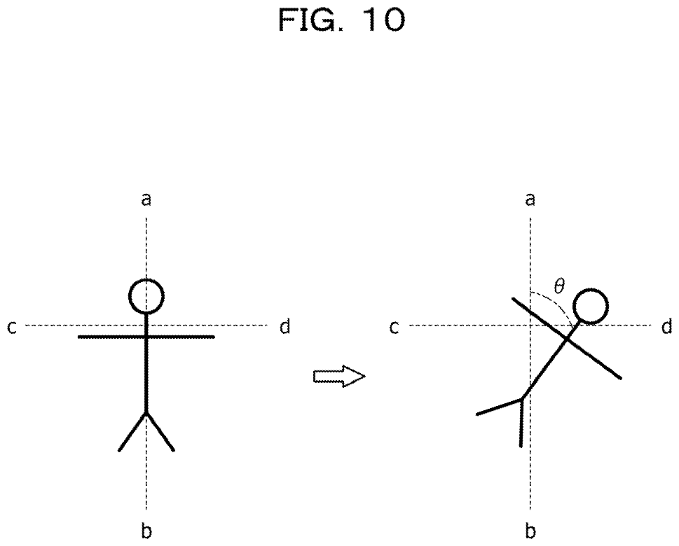

In the embodiments described above, an example has been described in which the rotation angle around the spine and the rotation angle around the both shoulders are used as the posture information. However, an angle value and a trigonometric function can be used as these rotation angles. FIG. 10 is a diagram for explaining an angle value and a trigonometric function. In FIG. 10, the axis of the spine is indicated by ab, and the axis of the both shoulders is indicated by cd. Then, when the axis of the spine of the performer is tilted by an angle θ from the ab axis, the recognition device 50 uses this angle 9 as an angle value. Alternatively, when the axis of the spine of the performer is tilted by the angle θ from the ab axis, the recognition device 50 uses sine or cos θ as a trigonometric function.

By using the angle value, a calculation cost can be reduced, and processing time of the learning processing and the recognition processing can be shortened. Furthermore, by using the trigonometric function, it is possible to accurately recognize a boundary of a change from 360 degrees to zero degrees, and it is possible to more improve the learning accuracy or the recognition accuracy than a case where the angle value is used. Note that, here, although an example in which the spine is used as the axis has been described, the axis around the both shoulders can be similarly processed. Furthermore, the learning device 10 can similarly execute processing.

[Application Example]

In the embodiment described above, the artistic gymnastics has been described as an example. However, the present embodiment is not limited to this, and the embodiment can be applied to other sports in which an athlete performs a series of techniques and a judge rates the performance. The other sports include, for example, figure skating, rhythmic gymnastics, cheerleading, diving, kata in karate, mogul, or the like. Furthermore, in addition to sports, the embodiment can be applied to posture detection of drivers of trucks, taxis, trains, or the like, posture detection of pilots, or the like.

[Skeleton Information]

Furthermore, in the embodiment described above, an example has been described in which the positions of the respective 18 joints are learned. However, the embodiment is not limited to this, and it is possible to specify and learn one or more joints. Furthermore, in the embodiment described above, as an example of the skeleton information, the position of each joint has been described. However, the embodiment is not limited to this, and various pieces of information can be adopted as long as information can be defined in advance, such as information regarding an angle of each joint, orientations of limbs, the orientation of the face, or the like.

[Learning Model]

Furthermore, various pieces of information including information indicating an orientation of a subject such as a rotation angle of the waist or the orientation of the head can be adopted as the posture information.

[System]

Pieces of information including a processing procedure, a control procedure, a specific name, various types of data, and parameters described above in the above document or illustrated in the drawings may be changed in any ways unless otherwise specified.

In addition, each component of each device illustrated in the drawings is functionally conceptual and does not necessarily have to be physically configured as illustrated in the drawings. In other words, for example, specific forms of distribution and integration of each device are not limited to those illustrated in the drawings. That is, for example, all or a part of the devices may be configured by being functionally or physically distributed and integrated in any units according to various types of loads, usage situations, or the like. For example, the learning device 10 and the recognition device 50 can be implemented with the same device.

Moreover, all or any part of each processing function performed in each device may be implemented by a central processing unit (CPU) and a program analyzed and executed by the CPU, or may be implemented as hardware by wired logic.

[Hardware]

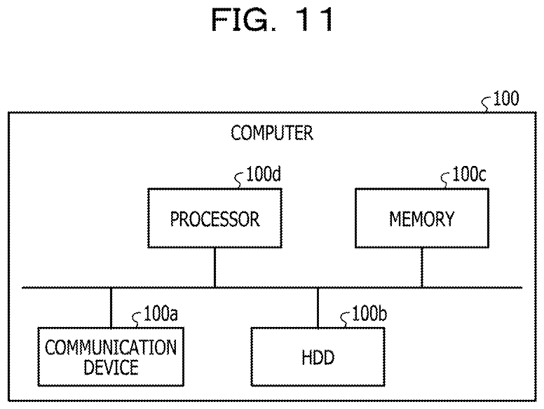

Next, a hardware configuration of the computer such as the learning device 10 and the recognition device 50 will be described. FIG. 11 is a diagram for explaining a hardware configuration example. As illustrated in FIG. 11, a computer 100 includes a communication device 100a, a Hard Disk Drive (HDD) 100b, a memory 100c, and a processor 100d. Furthermore, the units illustrated in FIG. 11 are mutually connected by a bus or the like.

The communication device 100a is a network interface card or the like and communicates with another server. The HDD 100b stores programs and databases (DBs) for activating the functions illustrated in FIG. 2.

The processor 100d reads a program that executes processing similar to the processing of each processing unit illustrated in FIG. 2 from the HDD 100b or the like, and develops the read program in the memory 100c, thereby activating a process that performs each function described with reference to FIG. 2 or the like. In other words, for example, this process executes a function similar to the function of each processing unit included in the recognition device 50. Specifically, for example, the processor 100d reads a program having a function similar to that of the recognition processing unit 70 or the like from the HDD 100b or the like. Then, the processor 100d executes a process for executing processing similar to that of the recognition processing unit 70 or the like.

As described above, the recognition device 50 operates as an information processing device that executes the recognition method by reading and executing the program. Furthermore, the recognition device 50 may also implement functions similar to the functions of the above-described embodiments, by reading the program described above from a recording medium by a medium reading device and executing the read program described above. Note that this program referred to in the other embodiments is not limited to being executed by the recognition device 50. For example, the embodiments may be similarly applied to a case where another computer or server executes the program, or a case where such a computer and a server cooperatively execute the program. Note that the learning device 10 can execute processing using a similar hardware configuration.

All examples and conditional language provided herein are intended for the pedagogical purposes of aiding the reader in understanding the invention and the concepts contributed by the inventor to further the art, and are not to be construed as limitations to such specifically recited examples and conditions nor does the organization of such examples in the specification relate to a shoving of the superiority and inferiority of the invention, Although one or more embodiments of the present invention have been described in detail, it should be understood that the various changes, substitutions, and alterations could be made hereto without departing from the spirit and scope of the invention.

What is claimed is:

1. A recognition method in which a computer executes processing comprising:
generating posture information used to specify a posture of a subject on the basis of a distance image that includes the subject;
inputting the distance image and the posture information to a learned model that is learned to recognize a skeleton of the subject; and
specifying the skeleton of the subject using an output result of the learned model.

2. The recognition method according to claim 1, wherein
the inputting processing inputs the distance image to an input layer of a neural network used for the learned model and inputs the posture information to a head intermediate layer of intermediate layers of the neural network.

3. The recognition method according to claim 1, wherein
the inputting processing inputs the distance image to an input layer of a convolutional neural network used for the learned model and inputs the posture information to a hidden layer of which a size of the input image is the smallest among hidden layers of the convolutional neural network.

4. The recognition method according to claim 1, wherein
the inputting processing inputs an angle value or a trigonometric function that indicates an orientation of the subject as the posture information.

5. The recognition method according to claim 4, wherein
the inputting processing inputs respective angle values of a rotation angle around a spine of the subject and a rotation angle around both shoulders of the subject or each trigonometric function using each rotation angle.

6. The recognition method according to claim 1, wherein
the generating processing generates an output result obtained by inputting the distance image to a learned model learned to output the posture information as the posture information.

7. The recognition method according to claim 1, wherein
the specifying processing acquires a heat map image that visualizes a likelihood of a joint position of the subject as the output result of the learned model and specifies a position with the highest likelihood in the heat map image as the joint position.

8. A non-transitory computer-readable recording medium having stored therein a recognition program for causing a computer to execute processing comprising:
generating posture information used to specify a posture of a subject on the basis of a distance image that includes the subject;
inputting the distance image and the posture information to a learned model that is learned to recognize a skeleton of the subject; and
specifying the skeleton of the subject using an output result of the learned model.

9. A learning method in which a computer executes processing comprising:
generating posture information that specifies a posture of a subject using skeleton information of the subject that is correct answer information associated with a distance image that is learning data and includes the subject;
inputting the distance image and the posture information to a learning model; and
learning the learning model using an output result of the learning model and the skeleton information.

10. The learning method according to claim 9, for causing the computer to execute processing further comprising:
generating a heat map image that visualizes a likelihood of a joint position of the subject from the skeleton information, wherein the learning processing acquires the heat map image as the output result of the learning model and learns the learning model according to a result of comparing the heat map image that is the output result with the heat map image generated from the skeleton information.

11. The learning method according to claim 9, wherein
the inputting processing inputs the distance image to an input layer of a neural network used for the learning model and inputs the posture information to a head intermediate layer of intermediate layers of the neural network.

12. The learning method according to claim 9, wherein
the inputting processing inputs the distance image to an input layer of a convolutional neural network used for the learning model and inputs the posture information to a hidden layer of which a size of the input image is the smallest among hidden layers of the convolutional neural network.

13. The learning method according to claim 9, wherein
the inputting processing inputs an angle value or a trigonometric function that indicates an orientation of the subject as the posture information.

14. The learning method according to claim 9, wherein
the inputting processing inputs respective angle values of a rotation angle around a spine of the subject and a rotation angle around both shoulders of the subject or each trigonometric function using each rotation angle.
